(19) United States
(12) Patent Application Publication
(10) Pub. No.: US 2026/0359848 A1
(43) Pub. Date: Nov. 12, 2026

(54) ARTIFICIAL INTELLIGENCE-BACKED VOICE SURVEY

(71) Applicant: International Business Machines Corporation, Armonk, NY (US)

(72) Inventors: Donna Thelander, Kailua Kona, HI (US); Tyler Waite, Lake Washington, WA (US); Jason Andrew Telner, Lackawanna, NY (US); Jon Gerard Temple, Southbury, CT (US); Mark Willard Malatesta, Ortonville, MI (US); Peter Guzewich, Vestal, NY (US)

(21) Appl. No.: 18/596,707

(22) Filed: Mar. 6, 2024

(51) Int. Cl. G06Q 30/0203

(52) U.S. Cl. CPC G06Q 30/0203

(57) ABSTRACT

According to one embodiment, a method, computer system, and computer program product for AI-backed voice surveying is provided. The embodiment may include transmitting a pre-defined query to a user. The embodiment may also include receiving a user response to the pre-defined query in real time while the user is interacting with a computing device. The embodiment may further include analyzing the user response for a sentiment, a tone, and a meaning. The embodiment may also include, in response to determining a follow-up query is needed to identify the sentiment, the tone, or the meaning, generating the follow-up query. The embodiment may further include presenting the follow-up query to the user on a graphical user interface of the computing device.

### BACKGROUND

The present invention relates generally to the field of computing, and more particularly to artificial intelligence.

Artificial intelligence (AI) relates to the ability of a machine to learn patterns and make predictions based on the learned patterns. Typically, artificial intelligence has been utilized to automate tasks that were historically performed by human intelligence. In its simplest form, artificial intelligence relates to a field that combines computer science and robust datasets to enable problem-solving. Artificial intelligence machines, often referred to as artificial intelligence services, encompass various technologies including speech recognition, pattern identification, machine learning, deep learning, and natural language processing.

### SUMMARY

According to one embodiment, a method, computer system, and computer program product for AI-backed voice surveying is provided. The embodiment may include transmitting a pre-defined query to a user. The embodiment may also include receiving a user response to the pre-defined query in real time while the user is interacting with a computing device. The embodiment may further include analyzing the user response for a sentiment, a tone, and a meaning. The embodiment may also include, in response to determining a follow-up query is needed to identify the sentiment, the tone, or the meaning, generating the follow-up query. The embodiment may further include presenting the follow-up query to the user on a graphical user interface of the computing device.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for an AI-backed voice survey process according to at least one embodiment.

FIG. 3 illustrates a functional block diagram of various inputs used in an AI-backed voice survey process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to artificial intelligence. The following described exemplary embodiments provide a system, method, and program product to, among other things, generate highly-specific and individualized follow-up questions to present to a user of a chatbot during a conversation. Therefore, the present embodiment has the capacity to improve the technical field of artificial intelligence by gathering more in-depth and well-rounded data that provides a greater understanding of the intent behind user prompts and queries as well as clarifying additional details in vague and unexpected answers.

As previously described, Artificial intelligence (AI) relates to the ability of a machine to learn patterns and make predictions based on the learned patterns. Typically, artificial intelligence has been utilized to automate tasks that were historically performed by human intelligence. In its simplest form, artificial intelligence relates to a field that combines computer science and robust datasets to enable problem-solving. Artificial intelligence machines, often referred to as artificial intelligence services, encompass various technologies including speech recognition, pattern identification, machine learning, deep learning, and natural language processing.

Conversational systems are a segment of artificial intelligence relating to technologies that enable users to communicate in natural language conversations with computer systems. Conversational systems are typically designed to mirror human interactions, which allows for interactions in speech or text. Conversational systems utilize many aspects of artificial intelligence to bring a fluid communication between a human and artificial entity, including natural language processing, machine learning, input generation and analysis, and dialogue management and response generation. Some common technologies that fall within the realm of conversational systems include intelligent chatbots, virtual agents, and voice assistants.

Conversational systems are becoming more and more present in many workplace environments. One such area is research surveys where a conversational system can engage with a survey taker, or user of the survey, to solicit feedback and responses to inquiries and areas of interest to a team of researchers. However, despite the many capabilities of conversational systems, current feedback methods often result in answers that are too vague to clearly understand or act upon and, due to the anonymous nature of most surveys, researchers are unable to ask clarifying questions or follow-up with the users. Users tend to provide better and more detailed feedback through conversation than when typing; partly due to fatigue as a survey continues. Furthermore, various survey methods (e.g., feedback button, interrupt, and email) are impersonal and easy for users to disregard, and the inability to ask clarifying questions can greatly decrease the usefulness of the data. As such, it may be advantageous to, among other things, develop a program capable of utilizing on-the-fly sentiment and language analysis to provide for a more realistic conversational user experience than context dependent interactions while also gathering more accurate and actionable feedback data.

According to at least one embodiment, an AI-backed voice survey program may utilize a natural language processing-focused foundation model trained on logical and lexical semantics to provide additional information on vague, unusual, or highly-specific, open-ended answer and greatly increase data quality while also reducing the number of users required for actionable, data-driven findings. The AI-backed voice survey program may allow for fine-tuning the foundation model on project-specific data regarding the tool(s) being surveyed, the team/organization, the users and user groups, the goal of the tool based on the user prompt, user flows, historical user feedback, and other user research data. The AI-backed voice survey program may also utilize prompt engineering to include sentiment analysis, semantic analysis, and exemplars of good responses. The AI-backed voice survey program may utilize a combination of natural language processing and machine learning with inputs from generative artificial intelligence to perform skills, such as intent recognition, disambiguation, entity extraction, and slot filling, to identify the context and meaning of user feedback. The AI-backed voice survey program may utilize the skills with sentiment, lexical, and logical semantics analyses to calculate a robustness score of a user prompt. If the AI-backed voice survey program determines a robustness score of a specific user prompt falls below a threshold value for one or more categories, the AI-backed voice survey program may trigger an action to generate a unique, highly-specific follow-up question that is in the appropriate tone.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

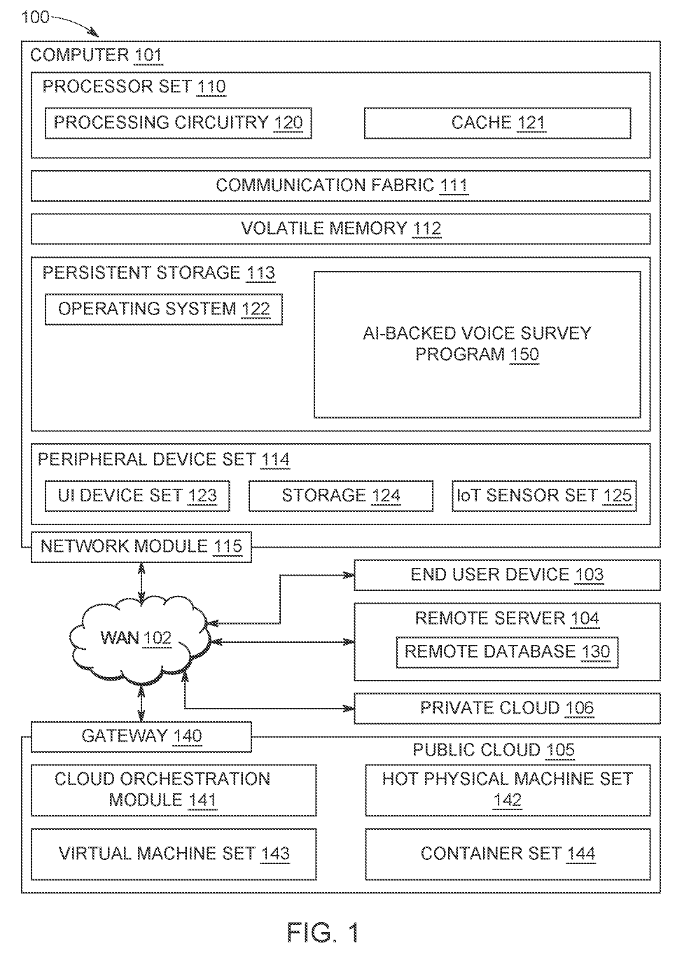

Referring now to FIG. 1, computing environment 100 contains an example of an environment for the execution of at least some of the computer code involved in performing the inventive methods, such as AI-backed voice survey program 150. In addition to AI-backed voice survey program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AI-backed voice survey program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AI-backed voice survey program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in AI-backed voice survey program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the AI-backed voice survey program 150 may transmit a pre-defined survey question to a user for completion. The AI-backed voice survey program 150 may analyze user interactions for sentiment, tone, and meaning upon receiving the user interactions with a computing device in real time while the user is responding to the survey question. If the AI-backed voice survey program 150 determines that the user response warrants a follow-up question based on the analysis, the AI-backed voice survey program 150 may generate and display a clarifying question. If the AI-backed voice survey program 150 determines a follow-up question is not warranted, the AI-backed voice survey program 150 may determine whether the survey is completed and, if so, end. However, if the AI-backed voice survey program 150 determines that the survey is not completed, the AI-backed voice survey program 150 may continue to the next question in the survey. Although, survey is used throughout, a survey may include any interaction between an artificial intelligence and a human user. For example, the survey may include a chat session between a user and a chatbot.

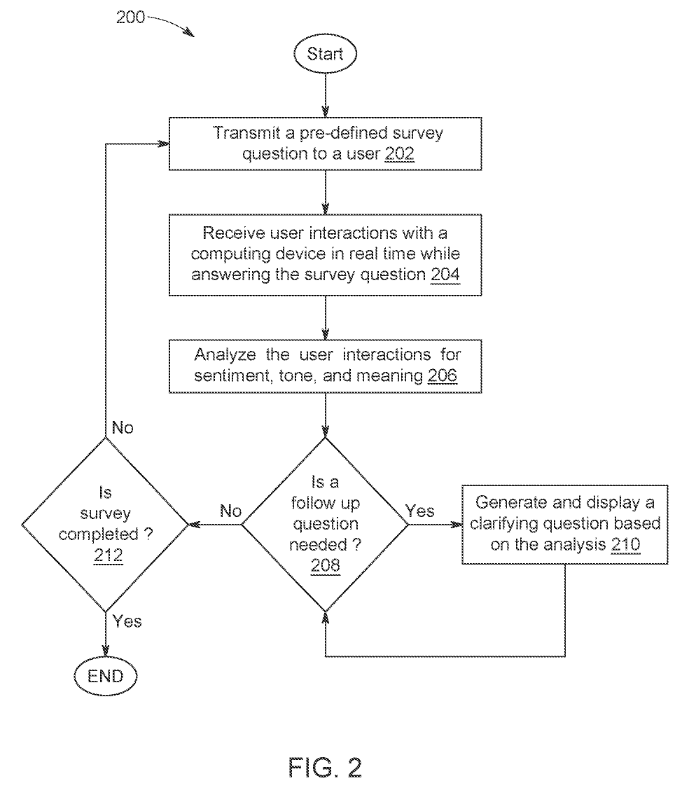

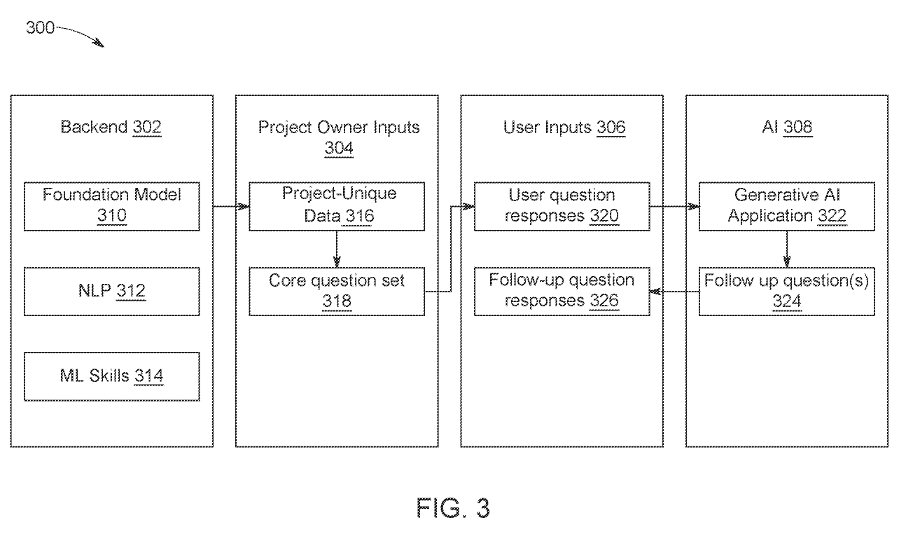

Additionally, prior to initially performing any actions, the AI-backed voice survey program 150 may perform an opt-in procedure. The opt-in procedure may include a notification of the data the AI-backed voice survey program 150 may capture and the purpose for which that data may be utilized by the AI-backed voice survey program 150 during data gathering and operation. Furthermore, notwithstanding depiction in computer 101, the AI-backed voice survey program 150 may be stored in and/or executed by, individually or in any combination, end user device 103, remote server 104, public cloud 105, and private cloud 106. The demand-aware screen sharing method is explained in more detail below with respect to FIGS. 2 and 3.

Referring now to FIG. 2, an operational flowchart for an AI-backed voice survey process 200 according to at least one embodiment. At 202, the AI-backed voice survey program 150 transmits a pre-defined survey question to a user. During the execution of a survey, the AI-backed voice survey program 150 may present a user with prompts customized to each user response received in a manner that mimics a conversation between the AI-backed voice survey program 150 and the user. In one or more alternate embodiments, the AI-backed voice survey program 150 may present the user with pre-defined survey questions in a preconfigured order by a survey developer or creator. In one or more embodiments, the AI-backed voice survey program 150 may present the pre-defined survey questions in writing or verbally through recorded or computer speech. For example, while a user is engaged with a website or application to complete a survey, the AI-backed voice survey program 150 may trigger audio to engage the user as “Hello! How is your experience using the system going today?” then lead into the pre-defined survey questions.

In an embodiment, at the presentation of the first question in a survey, the AI-backed voice survey program 150 may display one or more interactable icons for a user to select giving the user the option to verbally speak their responses and have the AI-backed voice survey program 150 utilize speech-to-text technology to enter their responses. In such situations, the AI-backed voice survey program 150 may present the artificial intelligence responses as either a text prompt and/or verbally using computer speech and text-to-speech technology.

When the AI-backed voice survey program 150 initiates, a user interface may be generated and displayed where the user can read the question and a field for a response may be entered. In embodiments where questions are verbally presented to the user, the AI-backed voice survey program 150 may display text corresponding to the spoken audio that allows the user to read along while the pre-defined question is spoken to the user.

Then, at 204, the AI-backed voice survey program 150 receives user interactions with a computing device in real time while the user is answering the survey question. When a user provides their responses to the AI-backed voice survey program 150, the AI-backed voice survey program 150 may capture the input text in real-time as the user is typing the response into a text field of the survey user interface. In embodiments where the user verbally answers questions, the AI-backed voice survey program 150 may utilize speech-to-text technology to transcribe the user response into the text field of the user interface. Additionally, the AI-backed voice survey program 150 may allow a user to edit their provided responses at any time prior to a user interaction with a close/submit button that will submit the user response to the AI-backed voice survey program 150.

Next, at 206, the AI-backed voice survey program 150 analyzes the user interactions for sentiment, tone, and meaning. The AI-backed voice survey program 150 may analyze the user response for sentiment, tone, and meaning to determine whether the response is sufficient or if additional detail is needed. In one or more embodiments, the AI-backed voice survey program 150 may conduct the analysis concurrently or in real-time as the user is submitting their response whether that be verbally where the AI-backed voice survey program 150 utilizes speech-to-text or by text entry to the text field using a peripheral device.

To determine the user response for sentiment, tone, and meaning, the AI-backed voice survey program 150 may analyze specific user words and phrases and voice inflections in the user response using a machine learning model trained on sentiment, tone, and meaning from historical user responses. As previously described, the AI-backed voice survey program 150 may utilize natural language processing and machine learning together with inputs from generative artificial intelligence to perform skill such as, but not limited to, intent recognition, disambiguation, entity extraction, and slot filling, to identify the context and meaning of the user interactions. The AI-backed voice survey program 150 may utilize these techniques to create a robustness score for the user response. The AI-backed voice survey program 150 may calculate the robustness score based on a variety of parameters, such as threshold number of words in the response, whether the user response includes words related to the tools/tasks being surveyed, vagueness, indications of a specific sentiment in the user response, and whether the user response incorporates a complete thought. The robustness score may be a numerical value of the quality of a user response with respect to the previous prompt presented by the AI-backed voice survey program 150. In one or more embodiments, the robustness score may be a percentage value of whether the user response fits into one or more of the parameter categories.

Then, at 208, the AI-backed voice survey program 150 determines whether a follow-up question is needed. The AI-backed voice survey program 150 may determine a follow-up question to clarify the user response is needed should the robustness score for a response fall below a threshold value. For example, if the AI-backed voice survey program 150 calculates a certain percentage of confidence that a user response is vague based on the words used in the user response, the AI-backed voice survey program 150 may compare the calculated robustness score against a preconfigured threshold value for vagueness and, if the calculated robustness score falls below the threshold, the AI-backed voice survey program 150 may determine a follow-up question should be generated to correct the vagueness or clarify the user response with further information. If the AI-backed voice survey program 150 determines a follow up question is needed (step 208, “Yes” branch), then the AI-backed voice survey process 200 may proceed to step 210 to generate and display a clarifying question based on the analysis. If the AI-backed voice survey program 150 determines a follow up question is not needed (step 208, “No” branch), then the AI-backed voice survey process 200 may proceed to step 212 to determine whether the survey is complete.

Next, at 210, the AI-backed voice survey program 150 generates and displays a clarifying question based on the analysis. As previously described, the AI-backed voice survey program 150 may typically generate a follow-up query or prompt when user response is deficient in one of several manners, such as lacking a threshold number of words, whether the user response includes words related to the tools/tasks being surveyed, vagueness, indications of a specific sentiment in the user response, and whether the user response incorporates a complete thought. As such, each situation may require a response to be generated that addresses that specific issue.

When assessing whether a user response contains a threshold number of words, the AI-backed voice survey program 150 may utilize sentence and grammar structural analysis as well as sentiment analysis to assess response length. In one or more embodiments, the AI-backed voice survey program 150 may be preconfigured to require a minimum number of words or characters in each survey response. However, in another embodiment, the AI-backed voice survey program 150 may establish a dynamic word threshold based on various factors including previous user response lengths, question asked, and a context of the user response currently being drafted in real time. For example, the user may respond to query of “How are you enjoying this application?” with a response “This tool is great!”. The AI-backed voice survey program 150 may analyze the response of “This tool is great!” as only having four words and, thus, being below a minimum word threshold. Therefore, the AI-backed voice survey program 150 may generate a prompt to illicit a more detailed response from the user, such as “That’s good to hear! Can you elaborate on what is good or working well?”.

The AI-backed voice survey program 150 may further assess whether a user response includes words related to the tools or tasks being surveyed. Thus, the AI-backed voice survey program 150 may assess whether a user response is on topic for the question being asked of the user. The AI-backed voice survey program 150 may utilize intent recognition, logical/lexical semantic analysis, and sentiment analysis in this determination. For example, when queried about how a user is liking an application, the user may respond with “Our workload is too high and the [other application name] is constantly freezing”. The AI-backed voice survey program 150 may analyze this response to determine that the user response is not applicable to the application for which a response is being asked. Therefore, the AI-backed voice survey program 150 may generate a responsive prompt of “I’d like to help. Can you elaborate how your challenges with [other application name] relate to [application being surveyed]? What can we improve?”.

Additionally, the AI-backed voice survey program 150 may assess vagueness in a user response by identifying words that are unclear or overly general in relation to the prompt. The AI-backed voice survey program 150 may utilize intent recognition, logical/lexical semantic analysis, sentence/grammar structural analysis, and sentiment analysis to make the determination of vagueness. For example, in response to a user response of “Using the application is too difficult and slow”, the AI-backed voice survey program 150 may generate a follow-up query of “I’m sorry to hear you having difficulties. Can you please explain which aspects of the program are difficult or slow?”.

The AI-backed voice survey program 150 may also utilize a sentiment determination or a determination that a user response does not make a complete thought as an opportunity to generate a follow-up query. To make such a determination, the AI-backed voice survey program 150 may utilize sentiment analysis, logical/lexical semantic analysis, sentence/grammar structural analysis, and the determined sentiment. As an example, the AI-backed voice survey program 150 may receive a user response stating “I can’t believe how awful this program is. It’s embarrassing”. That AI-backed voice survey program 150 may determine that one part of the response (i.e., “I can’t believe how awful this program is”) exhibits a strong sentiment of the application. In this particular statement, the AI-backed voice survey program 150 may determine that sentiment to extremely negative. Additionally, the AI-backed voice survey program 150 may determine another part of the user response (i.e., “It’s embarrassing”) to be an incomplete thought that might be of more value to the researchers or developers should it be expanded upon. To address both of these items, the AI-backed voice survey program 150 may generate a response stating “I hear your frustration and would like to help. Can you describe how you would prefer it to work?”.

In one or more embodiments, the AI-backed voice survey program 150 may present the clarifying question to the user in a user interface, such as a chat window in which a conversation is occurring. The AI-backed voice survey program 150 may receive a user response to the clarifying question in a similar manner as is described in step 202 and iterate through analysis of the user response to determine whether any further follow-up questions are necessary based on the robustness score for each parameter.

Then, at 212, the AI-backed voice survey program 150 determines whether the survey is complete. Once the AI-backed voice survey program 150 determines a user response, whether an original user response or a supplemental user response to a follow-up, clarifying question by the AI-backed voice survey program 150, is not necessary, the AI-backed voice survey program 150 may analyze the survey to determine if any further questions remain or if the survey is complete. The AI-backed voice survey program 150 may determine the survey is complete when no pre-defined questions remain to be presented to the user. For example, the AI-backed voice survey program 150 may be designed to greet the user with “Hello! What can I help you with today?” and “I’m glad I could help. Did you have anything else I can assist you with today?”. Once the AI-backed voice survey program 150 determines both pre-defined questions have been asked and the user response to the second question (i.e., “I’m glad I could help. Did you have anything else I can assist you with today?”), the AI-backed voice survey program 150 may end the conversation with the user.

If the AI-backed voice survey program 150 determines the survey is complete (step 212, “Yes” branch), then the AI-backed voice survey process 200 may terminate. If the AI-backed voice survey program 150 determines the survey is not complete (step 212, “No” branch), then the AI-backed voice survey process 200 may return to step 202 to transmit a pre-defined survey question to the user.

Referring now to FIG. 3, a functional block diagram 300 of various inputs used in an AI-backed voice survey process according to at least one embodiment. The AI-backed voice survey program 150 may include a backend 302, an artificial intelligence 308, and various inputs including, but not limited to, project owner inputs 304 and user inputs 306. Backend 302 may include foundation model 310, natural language processing 312, and machine learning skills 314. The backend 302 may intake or otherwise utilize project owner inputs 304 (i.e., project-unique data 316 and core question set 318). Project unique data 316 may be data input by the project owner that the elements of backend 302 (i.e., foundation model 310, natural language processing 312, and machine learning skills 314) utilize to fine tune their performance. Core question set 318 may include pre-defined questions from a researcher or developer that created the survey and require responses from a user during the survey. The AI-backed voice survey program 150 may then intake or otherwise utilize user inputs 306 to assess robustness. User inputs 306 may include user question responses 320 and follow-up question responses 326. Initially, the AI-backed voice survey program 150 may intake user question responses and utilize elements of artificial intelligence 308 (e.g., generative artificial intelligence application 322) to create follow-up questions 324 should a robustness score of user response questions 320 fall below a threshold. The AI-backed voice survey program 150 may then intake the follow-up question responses 326 from the user to supplement the original user question responses 320.

It may be appreciated that FIGS. 2 and 3 provide only an illustration of one implementation and do not imply any limitations with regard to how different embodiments may be implemented. Many modifications to the depicted environments may be made based on design and implementation requirements. For example, in one or more embodiments, the AI-backed voice survey program 150 may enable a user to edit previously given responses through interaction with an “edit” button or icon beside the response in the survey interface window. Upon receiving an edited response, the AI-backed voice survey program 150 may re-analyze prior and/or subsequent responses that may be affected by the edited response.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
transmitting a pre-defined query to a user;
receiving a user response to the pre-defined query in real time while the user is interacting with a computing device;
analyzing the user response for a sentiment, a tone, and a meaning;
in response to determining a follow-up query is needed to identify the sentiment, the tone, or the meaning, generating the follow-up query; and
presenting the follow-up query to the user on a graphical user interface of the computing device.

2. The method of claim 1, wherein the analyzing further comprises:
calculating a robustness score for the user response based on one or more preconfigured parameters.

3. The method of claim 2, wherein the preconfigured parameters are selected from a group consisting of a threshold number of words in the user response, whether the user response includes words related to a tool or a tasks being surveyed, vagueness of the user response, indications of a specific sentiment in the user response, and whether the user response incorporates a complete thought.

4. The method of claim 2, wherein determining whether a follow-up query is needed further comprises:
comparing the robustness score for each of the one or more preconfigured parameters to a preconfigured threshold value associated with each parameter.

5. The method of claim 1, wherein the user response is received as a first spoken audio and converted to a first plurality of text using speech-to-text technology, and wherein the follow-up query is converted from a second plurality of text to a second spoken audio using computer speech and text-to-speech technology.

6. The method of claim 2, wherein the robustness score is a numerical confidence value associated with one or more of the sentiment, the tone, and the meaning of the user response to the one or more parameters.

7. The method of claim 6, wherein the sentiment, the tone, and the meaning are further determined using intent recognition, disambiguation, entity extraction, and slot filling.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
transmitting a pre-defined query to a user;
receiving a user response to the pre-defined query in real time while the user is interacting with a computing device;
analyzing the user response for a sentiment, a tone, and a meaning;
in response to determining a follow-up query is needed to identify the sentiment, the tone, or the meaning, generating the follow-up query; and
presenting the follow-up query to the user on a graphical user interface of the computing device.

9. The computer system of claim 8, wherein the analyzing further comprises:
calculating a robustness score for the user response based on one or more preconfigured parameters.

10. The computer system of claim 9, wherein the preconfigured parameters are selected from a group consisting of a threshold number of words in the user response, whether the user response includes words related to a tool or a tasks being surveyed, vagueness of the user response, indications of a specific sentiment in the user response, and whether the user response incorporates a complete thought.

11. The computer system of claim 9, wherein determining whether a follow-up query is needed further comprises:
comparing the robustness score for each of the one or more preconfigured parameters to a preconfigured threshold value associated with each parameter.

12. The computer system of claim 8, wherein the user response is received as a first spoken audio and converted to a first plurality of text using speech-to-text technology, and wherein the follow-up query is converted from a second plurality of text to a second spoken audio using computer speech and text-to-speech technology.

13. The computer system of claim 9, wherein the robustness score is a numerical confidence value associated with one or more of the sentiment, the tone, and the meaning of the user response to the one or more parameters.

14. The computer system of claim 13, wherein the sentiment, the tone, and the meaning are further determined using intent recognition, disambiguation, entity extraction, and slot filling.

15. A computer program product, the computer program product comprising:
one or more computer-readable tangible storage media and program instructions stored on at least one of the one or more tangible storage media, the program instructions executable by a processor capable of performing a method, the method comprising:
transmitting a pre-defined query to a user;
receiving a user response to the pre-defined query in real time while the user is interacting with a computing device;
analyzing the user response for a sentiment, a tone, and a meaning;
in response to determining a follow-up query is needed to identify the sentiment, the tone, or the meaning, generating the follow-up query; and
presenting the follow-up query to the user on a graphical user interface of the computing device.

16. The computer program product of claim 15, wherein the analyzing further comprises:
calculating a robustness score for the user response based on one or more preconfigured parameters.

17. The computer program product of claim 16, wherein the preconfigured parameters are selected from a group consisting of a threshold number of words in the user response, whether the user response includes words related to a tool or a tasks being surveyed, vagueness of the user response, indications of a specific sentiment in the user response, and whether the user response incorporates a complete thought.

18. The computer program product of claim 16, wherein determining whether a follow-up query is needed further comprises:
comparing the robustness score for each of the one or more preconfigured parameters to a preconfigured threshold value associated with each parameter.

19. The computer program product of claim 15, wherein the user response is received as a first spoken audio and converted to a first plurality of text using speech-to-text technology, and wherein the follow-up query is converted from a second plurality of text to a second spoken audio using computer speech and text-to-speech technology.

20. The computer program product of claim 16, wherein the robustness score is a numerical confidence value associated with one or more of the sentiment, the tone, and the meaning of the user response to the one or more parameters.
